(19) United States
(12) Patent Application Publication
(10) Pub. No.: US 2010/0001601 A1
(43) Pub. Date: Jan. 7, 2010

(54) SPINDLE MOTOR, CARRIAGE ASSEMBLY, AND RECORDING MEDIUM DRIVE

(75) Inventor: Yasuhiro Miura, Kunitachi (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/559,060

(22) Filed: Sep. 14, 2009

Related U.S. Application Data
(63) Continuation of application No. PCT/JP2007/058425, filed on Apr. 18, 2007.

(51) Int. Cl. H02K 5/10

(52) U.S. Cl. 310/88

(57) ABSTRACT

According to one embodiment, a spindle motor includes a cylindrical body, a rotor, and a stator. The cylindrical body defines a cylindrical space having the center axis on the rotational axis. The rotor includes an annular body that is connected to one end of the cylindrical body and defines an opening of the cylindrical space. The stator closes the opening while rotatably supporting the rotor. The clearance is formed between the stator and the annular body throughout the circumference of the annular body. The clearance becomes narrower in a direction away from the cylindrical space.

### CROSS-REFERENCE TO RELATED APPLICATIONS

This application is a continuation of PCT international application Ser. No. PCT/JP2007/058425 filed on Apr. 18, 2007 which designates the United States, incorporated herein by reference.

### BACKGROUND

1. Field

One embodiment of the invention relates to a spindle motor and a carriage assembly incorporated into a recording medium drive such as a hard disk drive.

2. Description of the Related Art

A magnetic disk is incorporated into the housing of a hard disk drive (HDD). The magnetic disk is mounted on a spindle motor. A flying head slider faces a surface of the magnetic disk at a predetermined floating height by the action of an air flow generated by the rotation of the magnetic disk. The flying head slider is supported at the end of a carriage assembly. The flying head slider write and read magnetic data by following a predetermined moving path on the magnetic disk by the swinging of the carriage assembly.

The spindle motor and the carriage assembly are assembled for manufacturing the HDD. Before the assembling, the cleaning process is performed on components of the spindle motor and the carriage assembly. After the cleaning process, the components are assembled. The assembling is executed in a clean room. The spindle motor and the carriage assembly are thus manufactured. The manufactured spindle motor and carriage assembly are housed in the housing. In this manner, the HDD is manufactured. Reference may be had to, for example, Japanese Patent Application National Publication No. H10-503832, and Japanese Patent Application Publication (KOKAI) No. H8-243336

The contact of the components at assembling cannot be avoided. Dust particles are caused by the contact. The dust particles adhere to the spindle motor and the carriage assembly. A lubricating oil and grease are used for the bearing of the spindle motor and the carriage assembly. The cleaning process of the assembled spindle motor and carriage assembly is limited to an air cleaning process. As a result, the dust particles in the HDD cannot be completely removed. When the dust particles are absorbed to the magnetic disk and the flying head slider and collide with the flying head slider, head crush is caused. The dust particles damage the HDD.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal configuration of a hard disk drive (HDD) as a specific example of a recording medium drive according to an embodiment of the invention;

FIG. 2 is an exemplary cross-sectional view of a spindle motor and a carriage assembly taken along line 2-2 of FIG. 1 according to a first embodiment of the invention;

FIG. 3 is an exemplary cross-sectional view of a clearance formed between a bracket and a flange in the first embodiment;

FIG. 4 is an exemplary cross-sectional view of a clearance formed between an annular body and a support shaft in the first embodiment;

FIG. 5 is an exemplary cross-sectional view of a spindle motor unit in the first embodiment;

FIG. 6 is an exemplary partially enlarged sectional view of the clearance into which water enters in the first embodiment;

FIG. 7 is an exemplary cross-sectional view taken along line 7-7 of FIG. 6;

FIG. 8 is an exemplary cross-sectional view of a carriage assembly unit in the first embodiment;

FIG. 9 is an exemplary graph of the number of dust particles before and after the cleaning process in the first embodiment;

FIG. 10 is an exemplary cross-sectional view of a spindle motor according to a second embodiment of the invention;

FIG. 11 is an exemplary cross-sectional view of a spindle motor according to a third embodiment of the invention;

FIG. 12 is an exemplary cross-sectional view of a spindle motor according to a fourth embodiment of the invention;

FIG. 13 is an exemplary partially enlarged sectional view of a spindle motor according to a fifth embodiment of the invention;

FIG. 14 is an exemplary partially enlarged sectional view of the clearance into which water enters in the fifth embodiment;

FIG. 15 is an exemplary partially enlarged sectional view of a spindle motor according to a sixth embodiment of the invention;

FIG. 16 is an exemplary cross-sectional view of a spindle motor according to a seventh embodiment of the invention;

FIG. 17 is an exemplary cross-sectional view of a spindle motor unit; and

FIG. 18 is an exemplary cross-sectional view of a carriage assembly unit according to an embodiment of the invention.

### DETAILED DESCRIPTION

Various embodiments according to the invention will be described hereinafter with reference to the accompanying drawings. In general, according to one embodiment of the invention, a spindle motor comprises a cylindrical body, a rotor, and a stator. The cylindrical body is configured to define a cylindrical space with a center axis on a rotational axis. The rotor comprises an annular body configured to be connected to one end of the cylindrical body and define an opening of the cylindrical space. The stator is configured to close the opening while rotatably supporting the rotor. A clearance is formed between the stator and the annular body throughout the circumference of the annular body. The clearance becomes narrower in a direction away from the cylindrical space.

According to another embodiment of the invention, a recording medium drive comprises a housing, a cylindrical body, a rotor, and a stator. The cylindrical body is housed in the housing and is configured to define a cylindrical space with a center axis on a rotational axis. The rotor comprises an annular body configured to be connected to one end of the cylindrical body and define an opening of the cylindrical space. The stator is configured to close the opening while rotatably supporting the rotor. A clearance is formed between the stator and the annular body throughout the circumference of the annular body. The clearance becomes narrower in a direction away from the cylindrical space.

According to still another embodiment of the invention, a spindle motor comprises a cylindrical support shaft, a cylindrical body, a bearing, and an annular body. The cylindrical support shaft has a center axis on a rotational axis. The cylindrical body is configured to define a cylindrical space with a center axis on a rotational axis and receive the support shaft in the cylindrical space. The bearing is arranged in the cylindrical space. The bearing is configured to couple the support shaft and the cylindrical body so that the support shaft and the cylindrical body are relatively movable. The annular body is configured to partition the cylindrical space around the support shaft and define a clearance that becomes narrower toward an outer end of the clearance between the support shaft and the cylindrical body throughout the circumference of the support shaft.

According to still another embodiment of the invention, a recording medium drive comprises a housing, a cylindrical support shaft, a cylindrical body, a bearing, and an annular body. The cylindrical support shaft is housed in the housing with a center axis on a rotational axis. The cylindrical body is configured to define a cylindrical space with a center axis on a rotational axis and receive the support shaft in the cylindrical space. The bearing is arranged in the cylindrical space. The bearing is configured to couple the support shaft and the cylindrical body so that the support shaft and the cylindrical body are relatively movable. The annular body is configured to partition the cylindrical space around the support shaft and define a clearance that becomes narrower toward an outer end of the clearance between the support shaft and the cylindrical body throughout the circumference of the support shaft.

According to still another embodiment of the invention, a spindle motor comprises a cylindrical body, a rotor, and a stator. The cylindrical body is configured to define a cylindrical space with a center axis on a rotational axis. The rotor comprises an annular body configured to be connected to one end of the cylindrical body and define an opening of the cylindrical space. The stator is configured to close the opening while rotatably supporting the rotor. A clearance is formed between the stator and the annular body throughout the circumference of the annular body. The rotor and the stator are configured to be coated with a water repellent agent at an inner end of the clearance.

According to still another embodiment of the invention, a recording medium drive comprises a housing, a cylindrical body, a rotor, a stator, and a water repellent agent. The cylindrical body is housed in the housing and is configured to define a cylindrical space with a center axis on a rotational axis. The rotor comprises an annular body configured to be connected to one end of the cylindrical body and define an opening of the cylindrical space. The stator is configured to close the opening while rotatably supporting the rotor. A clearance is formed between the stator and the annular body throughout the circumference of the annular body. The water repellent agent is configured to be applied to the rotor and the stator at an inner end of the clearance.

According to still another embodiment of the invention, a spindle motor unit comprises a cylindrical body, a rotor, a stator, a cylindrical portion, a cap, and an elastic body. The cylindrical body is configured to define a cylindrical space with a center axis on a rotational axis. The rotor comprises an annular body configured to be connected to one end of the cylindrical body and define an opening of the cylindrical space. The stator is configured to close the opening while rotatably supporting the rotor, and comprises a base configured to form a clearance between the stator and the annular body throughout the circumference of the annular body. The cylindrical portion is formed in the base around the rotor. The cap is configured to be fitted in the cylindrical portion. The rotor is housed between the cap and the base. The elastic body is configured to be interposed between the cylindrical portion and the cap.

According to still another embodiment of the invention, a carriage assembly comprises a cylindrical support shaft, a carriage block body, a carriage arm, a bearing, and an annular body. The cylindrical support shaft has a center axis on a rotational axis. The carriage block body is configured to define a cylindrical space with a center axis on a rotational axis and receive the support shaft in the cylindrical space. The carriage arm extends from the carriage block body. The bearing is arranged in the cylindrical space and is configured to couple the support shaft and the carriage block body so that the support shaft and the carriage block body are relatively movable. The annular body is configured to partition the cylindrical space around the support shaft and define a clearance that becomes narrower toward an outer end of the clearance between the support shaft and the carriage block body throughout the circumference of the support shaft.

According to still another embodiment of the invention, a recording medium drive comprises a housing, a cylindrical support shaft, a carriage block body, a carriage arm, a bearing, and an annular body. The cylindrical support shaft is housed in the housing with a center axis on a rotational axis. The carriage block body is configured to define a cylindrical space with a center axis on a rotational axis and receive the support shaft in the cylindrical space. The carriage arm extends from the carriage block body. The bearing is arranged in the cylindrical space and is configured to couple the support shaft and the carriage block body so that the support shaft and the carriage block body are relatively movable. The annular body is configured to partition the cylindrical space around the support shaft and define a clearance that becomes narrower toward an outer end of the clearance between the support shaft and the carriage block body throughout the circumference of the support shaft.

According to still another embodiment of the invention, a carriage assembly unit comprises a cylindrical support shaft, a carriage block body, a carriage arm, a bearing, a cap, and an elastic body. The cylindrical support shaft has a center axis on a rotational axis. The carriage block body is configured to define a cylindrical space with a center axis on a rotational axis and receive the support shaft in the cylindrical space. The carriage arm extends from the carriage block body. The bearing is arranged in the cylindrical space and is configured to couple the support shaft and the carriage block body so that the support shaft and the carriage block body are relatively movable. The cap is configured to be fitted in the carriage block body and seal the cylindrical space. The elastic body is configured to be interposed between the carriage block body and the cap.

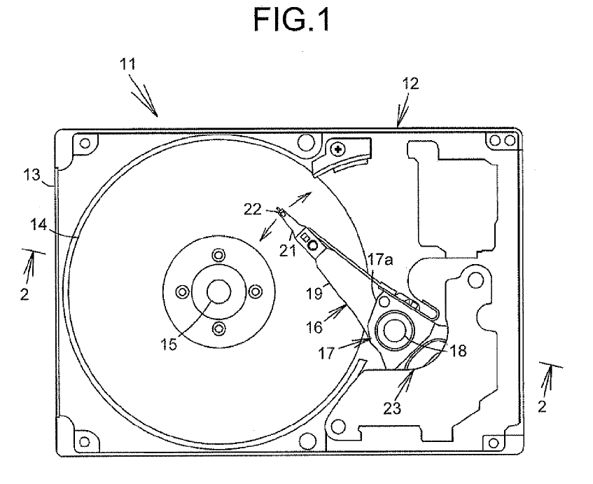

FIG. 1 schematically illustrates an internal configuration of a hard disk drive (HDD) 11 as an example of a recording medium drive according to an embodiment of the invention. The HDD 11 comprises a housing 12. The housing 12 has a box-shaped base 13 and a cover (not illustrated). The base 13 defines the flat rectangular parallelepiped internal space, i.e., a housing space. The base 13 may be molded by casting from a metal material such as aluminum. The cover is coupled to the opening of the base 13. The housing space is sealed between the cover and the base 13. The cover may be molded of one plate material by pressing.

One or more magnetic disks 14 as recording media are housed in the housing space. It is assumed herein that, for example, four magnetic disks 14 are housed. Each of the magnetic disks 14 is mounted on a spindle motor 15. The spindle motor 15 can rotate the magnetic disk 14 at high speed, such as 3600 rpm, 4200 rpm, 5400 rpm, 7200 rpm, 10000 rpm, and 15000 rpm. The detail of the spindle motor 15 will be described later.

A carriage assembly 16 is also housed in the housing space. The carriage assembly 16 comprises a carriage block 17. The carriage block 17 has a carriage block body 17a rotatably coupled to a support shaft 18 extending in the vertical direction. A plurality of carriage arms 19 extending from the support shaft 18 in the horizontal direction are integrated with the carriage block body 17a. The carriage block 17 may be molded of aluminum by extrusion molding.

A head suspension 21 is attached to the end of each of the carriage arms 19. The head suspension 21 extends forward from the end of the carriage arm 19. A flexure is attached to the front end of the head suspension 21. A flying head slider 22 is supported on the flexure. The flying head slider 22 can change its posture with respect to the head suspension 21 by the flexure. A magnetic head, i.e., an electromagnetic transducer device, is mounted on the flying head slider 22.

When an air flow is generated on a surface of the magnetic disk 14 by the rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating at relatively high rigidity during the rotation of the magnetic disk 14.

The carriage assembly 16 rotates about the support shaft 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic transducer device on the flying head slider 22 is positioned on the target recording track.

The carriage block 17 is connected to a power source such as a voice coil motor (VCM) 23. The carriage block 17 can be rotated about the support shaft 18 by the action of the VCM 23. The swinging of the carriage arm 19 and the head suspension 21 can be realized by the rotation of the carriage block 17. The detail of the carriage assembly 16 and the VCM 23 will be described later.

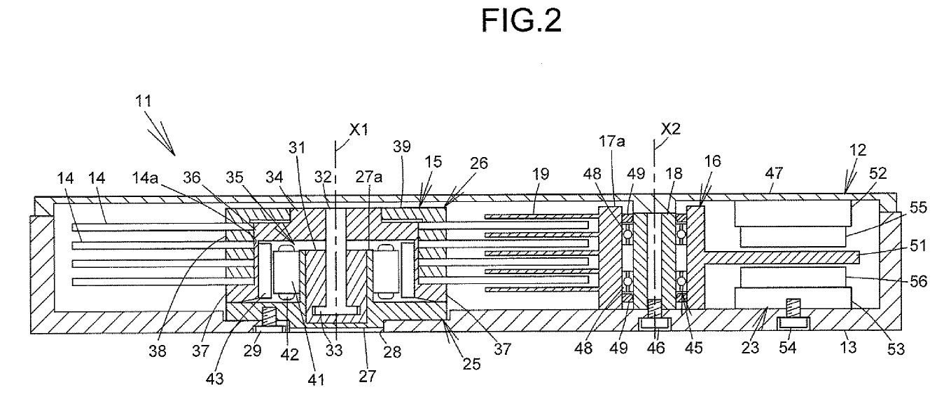

The configuration of the spindle motor 15 according to a first embodiment of the invention will be described in detail. As illustrated in FIG. 2, the spindle motor 15 comprises a stator 25. The stator 25 rotatably supports a rotor 26. The stator 25 has a bracket 27 received by the base 13. The bracket 27 is received into a receiving hole 28 penetrated into the bottom plate of the base 13. A cylindrical portion 27a erected from the surface of the bracket 27 in the vertical direction is defined in the bracket 27. The bracket 27 is fixed to the base 13 by a screw 29. The bracket 27 is cut out from an aluminum profile. The bracket 27 may be formed by extrusion molding.

The stator 25 has a sleeve 31 received by the cylindrical portion 27a. The sleeve 31 may be formed of a metal material such as brass and stainless steel. A shaft 32 is received into the cylindrical space of the sleeve 31. A fluid such as a lubricating oil is filled between the sleeve 31 and the shaft 32. The shaft 32 can be rotated at high speed about the axis of the shaft 32, i.e., a rotational axis X1, by the action of the fluid. A thrust flange 33 extending from the rotational axis X1 in the centrifugal direction is attached to the lower end of the shaft 32. The shaft 32 and the thrust flange 33 may be formed of a metal material such as stainless steel.

The rotor 26 has a spindle hub 34 fitted to the shaft 32. The spindle hub 34 defines a cylindrical body 36 defining a cylindrical space 35 having a center axis on the rotational axis X1. An annular body, i.e., a flange 37 extending outward from the cylindrical body 36, is connected to one end, i.e., the lower end of the cylindrical body 36. The flange 37 defines the opening of the cylindrical space 35. The opening is sealed by the bracket 27. The cylindrical space 35 is opened only at the opening.

The magnetic disks 14 are fitted in the spindle hub 34. A throughhole 14a is penetrated into the center of each of the magnetic disks 14 in fitting. The throughhole 14a receives the spindle hub 34. An annular spacer 38 is interposed between the magnetic disks 14. The annular spacer 38 holds the space between the magnetic disks 14. A clamp 39 is fitted to the upper end of the spindle hub 34. The magnetic disks 14 and the annular spacers 38 are interposed between the clamp 39 and the flange 37.

The stator 25 has a group of stator cores 41 fixed onto the cylindrical outer circumferential surface of the cylindrical portion 27a. An electromagnet, i.e., a coil 42, is wound around the core 41. The core 41 is configured by plural stacked metal thin plates. The cylindrical inner circumferential surface of the spindle hub 34 is opposite the cylindrical outer circumferential surface of the cylindrical portion 27a. A permanent magnet 43 is fixed to the cylindrical inner circumferential surface of the spindle hub 34. The permanent magnet 43 is opposite the coil 42. When an electric current is supplied to the coil 42, the spindle hub 34 is rotated about the rotational axis X1 by a magnetic field generated in the coil 42.

The configuration of the carriage assembly 16 according to the first embodiment will be described in detail. A cylindrical space 45 erected from the surface of the base 13 is defined in the carriage block body 17a. The support shaft 18 is housed in the cylindrical space 45. The support shaft 18 has a center axis on a rotational axis X2. The center axis of the cylindrical space 45 coincides with the rotational axis X2. The support shaft 18 is fixed onto the base 13 by a screw 46. The upper end of the support shaft 18 receives a cover 47 coupled to the base 13.

A bearing, i.e., a ball bearing 48, is arranged between the support shaft 18 and the carriage block body 17a in the cylindrical space 45. The ball bearing 48 relatively and rotatably couples the support shaft 18 and the carriage block body 17a. Grease is coated into the ball bearing 48. A pair of annular bodies 49 are arranged outside the ball bearing 48. Each of the annular body 49 partitions the cylindrical space 45 around the support shaft 18. The outer circumferential surface of the annular body 49 is attached to the inner circumferential surface of the carriage block body 17a. The detail of the annular body 49 will be described later.

A protrusion section 51 is integrated with the carriage block body 17a. A coil (not illustrated) is formed on the protrusion section 51. The protrusion section 51 is arranged between an upper yoke 52 and a lower yoke 53 of the VCM 23. The lower yoke 53 is fixed to the base 13 by a screw 54. The coil of the protrusion section 51 is opposite a permanent magnet 55 stuck onto the inward surface of the upper yoke 52 and a permanent magnet 56 stuck onto the inward surface of the lower yoke 53. The swinging of the carriage assembly 16 is caused by the magnetic action of the coil and the permanent magnets 55 and 56.

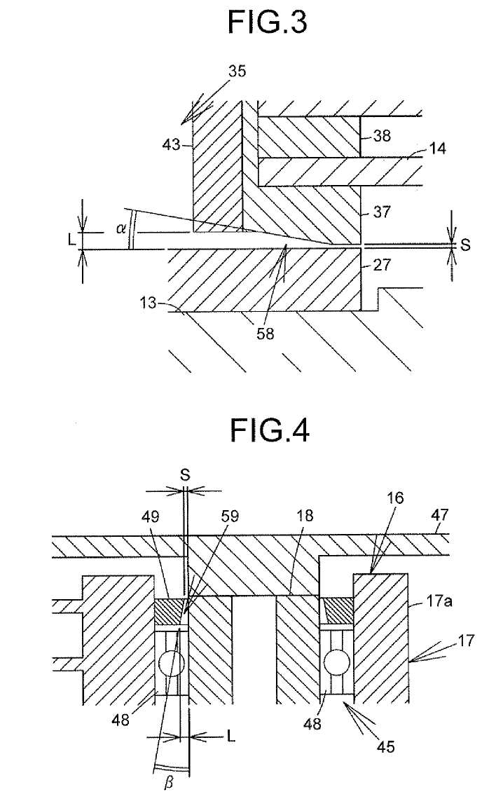

As illustrated in FIG. 3, the bracket 27 forms a clearance 58 that gradually becomes narrower or smaller in a direction away from the cylindrical space 35 between the bracket 27 and the flange 37 throughout the circumference of the flange 37. The lower surface of the flange 37 is inclined and gradually becomes closer to the upper surface of the bracket 27 in the direction away from the cylindrical space 35. The bracket 27 faces the flange 37 with the smallest space S therebetween. The smallest space S is defined at the outer end of the clearance 58. The smallest space S is set to 0.1 mm or less. The bracket 27 faces the flange 37 with the largest space L therebetween. The largest space L is defined at the inner end of the clearance 58. The largest space L is set to 0.2 mm or less. The smallest space S and the largest space L are set to be larger than 0 mm. A cross angle α between the upper surface of the bracket 27 and the lower surface of the flange 37 is set to 8° or less. The cross angle α is set to be larger than 0°.

As illustrated in FIG. 4, the annular body 49 forms a clearance 59 that gradually becomes narrower or smaller toward the outer end of the clearance 59 between the annular body 49 and the support shaft 18 throughout the circumference of the support shaft 18. The inner circumferential surface of the annular body 49 may be formed by an inclined surface that is close to the outer circumferential surface of the support shaft 18 as the inclined surface is toward the outer end of the clearance 59. The annular body 49 faces the support shaft 18 with the smallest space S therebetween that is defined at the outer end of the clearance 59. The smallest space S is set to 0.1 mm or less. The annular body 49 faces the support shaft 18 with the largest space L therebetween that is defined at the inner end of the clearance 59. The largest space L is set to 0.2 mm or less. The smallest space S and the largest space L are set to be larger than 0 mm. A cross angle β between the inner circumferential surface of the annular body 49 and the outer circumferential surface of the support shaft 18 is set to 8° or less. The cross angle β is set to be larger than 0°.

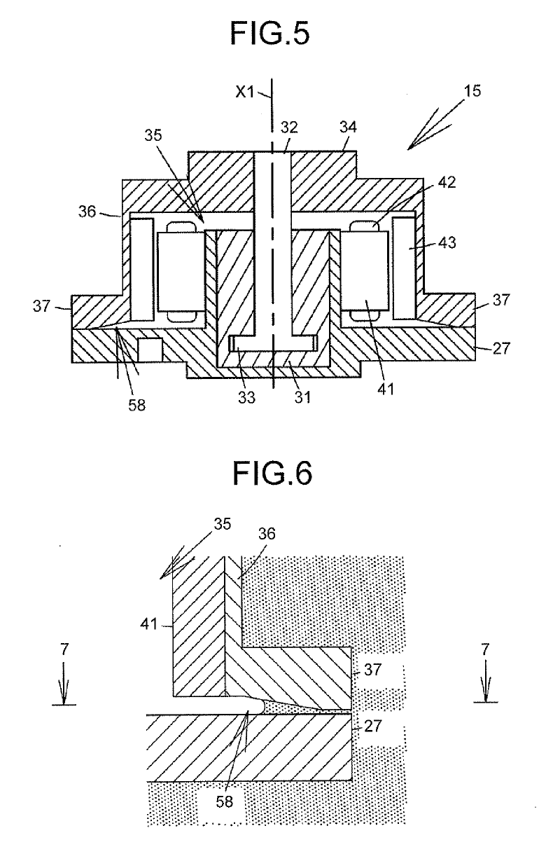

The state that the HDD 11 is assembled will be assumed. Before assembling the HDD 11, as illustrated in FIG. 5, the spindle motor 15 is assembled. The spindle motor 15 has the bracket 27, the sleeve 31, the shaft 32, and the spindle hub 34. The lubricating oil is filled between the shaft 32 and the sleeve 31. The permanent magnet 43 is attached to the spindle hub 34. The core 41 and the coil 42 are fitted into the bracket 27. The cleaning process is subjected to the spindle motor 15. Pure water is used for the cleaning process. Liquid hydrocarbon may be used for the cleaning process.

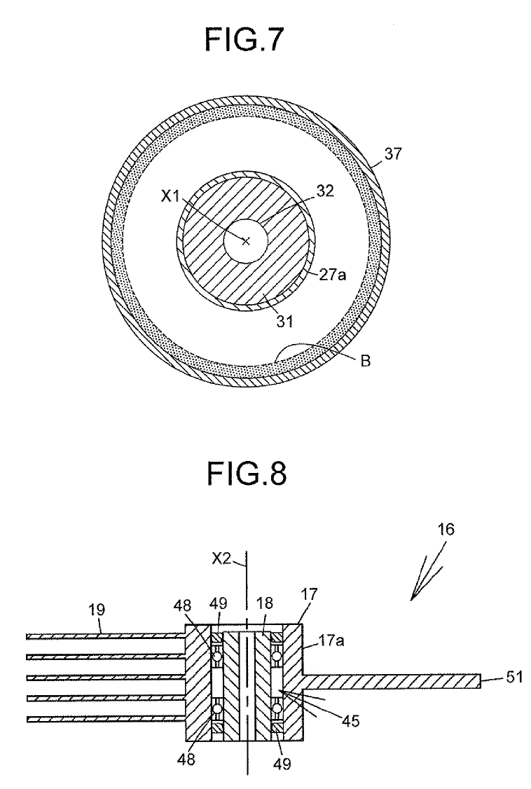

The spindle motor 15 is immersed into the pure water. As illustrated in FIG. 6, the pure water enters into the cylindrical space 35 from the clearance 58 formed by the bracket 27 and the flange 37. The clearance 58 gradually becomes narrower or smaller in a direction away from the cylindrical space 35. The air pressure and the water pressure of the cylindrical space 35 are balanced in a predetermined position in the clearance 58. A large surface tension is generated in the pure water between the outer end and the inner end of the clearance 58. The pure water establishes the meniscus shape in the clearance 58 by the balance of the air pressure, the water pressure, and the surface tension. As illustrated in FIG. 7, an interface B between the air and the pure water is defined along a circle drawn about the rotational axis X1. The pressures are balanced throughout the circumference of the flange 37. The entering of the pure water into the cylindrical space 35 can be avoided. The cleaning process of the outer surface of the spindle motor 15 is allowed after the spindle motor 15 is assembled. Dust particles are removed from the outer surface of the spindle motor 15.

As illustrated in FIG. 8, the carriage assembly 16 is assembled. The carriage assembly 16 has the carriage block 17, the support shaft 18, the ball bearing 48, and the annular body 49. Grease is coated into the ball bearing 48. The cleaning process is subjected to the carriage assembly 16. Pure water is used for the cleaning process. Liquid hydrocarbon may be used for the cleaning process.

The carriage assembly 16 is immersed into the pure water. The pure water enters into the cylindrical space 45 from the clearance 59 formed by the annular body 49 and the support shaft 18. The clearance 59 gradually becomes narrower or smaller in a direction away from the cylindrical space 45. A large surface tension is generated in the pure water between the outer end and the inner end of the clearance 59. The pure water establishes the meniscus shape in the clearance 59 by the balance of the air pressure, the water pressure, and the surface tension. The pressures are balanced throughout the circumference of the annular body 49. The entering of the pure water into the cylindrical space 45 can be avoided. The cleaning process of the outer surface of the carriage assembly 16 is allowed after the carriage assembly 16 is assembled. Dust particles are removed from the outer surface of the carriage assembly 16.

The drying process is subjected to the cleaned spindle motor 15 and the carriage assembly 16. The spindle motor 15 and the carriage assembly 16 are placed into a drying furnace for the drying process. After the drying process, the magnetic disk 14, the annular spacer 38, and the clamp 39 are fitted in the spindle motor 15. The head suspension 21 is attached to the carriage assembly 16. As is known, the spindle motor 15 and the carriage assembly 16 are attached to the base 13. The HDD 11 is thus manufactured. The adhesion of dusts particles into the HDD 11 can be avoided as much as possible.

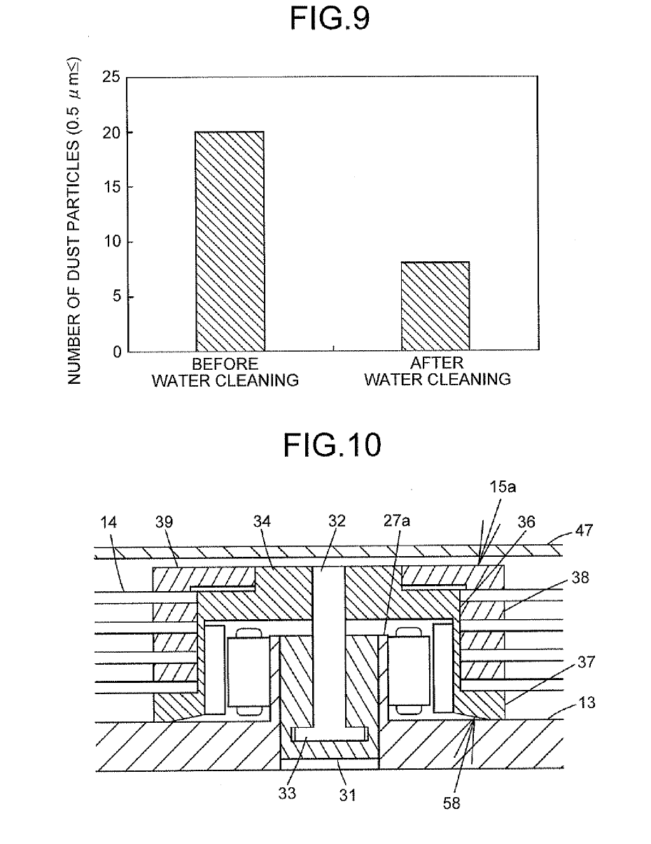

The inventors examined the effect of the cleaning process. The spindle motor 15 was attached to the base 13 for the examination. In the manner as described above, the spindle motor 15 was immersed in the pure water together with the base 13. The number of dust particles adhering to the spindle motor 15 and the base 13 was observed before and after the cleaning process. The number of dust particles larger than 0.5 μm was observed. As illustrated in FIG. 9, the number of dust particles was substantially reduced by the cleaning process. It was found that the dust particles adhering to the outer surface of the spindle motor 15 and the base 13 were removed by the cleaning process. The importance of the cleaning process was proven.

In the HDD 11, in the formation of the clearance 58 the upper surface of the bracket 27 may be formed by an inclined surface that is close to the lower surface of the flange 37 as the inclined surface is far away from the cylindrical space 35. The upper surface of the bracket 27 and the lower surface of the flange 37 may be formed by inclined surfaces that are close to each other as the inclined surfaces are far away from the cylindrical space 35. In the formation of the clearance 59, the outer circumferential surface of the support shaft 18 may be formed by an inclined surface that is close to the inner circumferential surface of the annular body 49 as the inclined surface is toward the outer end of the clearance 59. The outer circumferential surface of the support shaft 18 and the inner circumferential surface of the annular body 49 may be formed by inclined surfaces that are close to each other as the inclined surfaces are toward the outer end of the clearance 59. The clearance 59 may be defined between the outer circumferential surface of the annular body 49 and the inner circumferential surface of the carriage block body 17a. The annular body 49 may be integrated with the carriage block body 17a and may be integrated with the support shaft 18.

FIG. 10 schematically illustrates the configuration of a spindle motor 15a according to a second embodiment of the invention. The bracket 27 is integrated with the base 13 in the spindle motor 15a. The clearance 58 is formed between the surface of the bottom plate of the base 13 and the lower surface of the flange 37. The same configurations and structures as those of the spindle motor 15 are indicated by similar reference numerals. The spindle motor 15a can realize the same operation effect as that of the spindle motor 15. A spindle motor unit 61 comprises the base 13. The cleaning process of the spindle motor unit 61 is allowed. Dust particles can be efficiently removed from the base 13 having a large surface area.

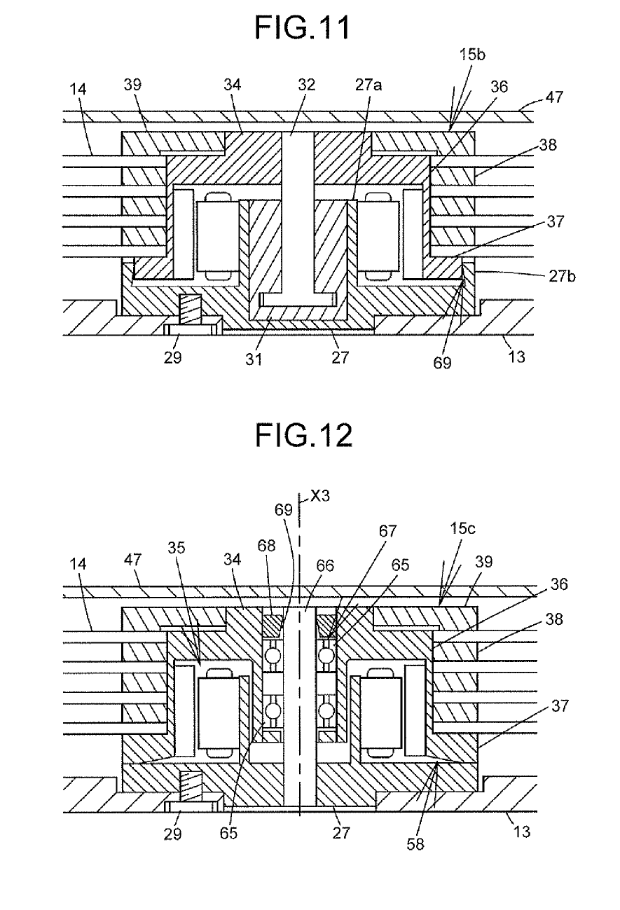

FIG. 11 schematically illustrates the configuration of a spindle motor 15b according to a third embodiment of the invention. A cylindrical portion 27b erected from the outer edge of the bracket 27 is formed in the bracket 27 in the spindle motor 15b. The inner circumferential surface of the cylindrical portion 27b is opposite the cylindrical outer circumferential surface of the flange 37. The cylindrical portion 27b forms a clearance 69 that gradually becomes narrower or smaller in a direction away from the cylindrical space 35 between the cylindrical portion 27b and the flange 37 throughout the circumference of the flange 37. The inner circumferential surface of the cylindrical portion 27b may be formed by an inclined surface that is close to the cylindrical outer circumferential surface of the flange 37 as the inclined surface is far from the cylindrical space 35. The clearance 69 has the same configuration as that of the clearance 58. The same configurations and structures as those of the spindle motor 15 are indicated by similar reference numerals. As in the clearance 58, the clearance 69 prevents the entering of the pure water into the cylindrical space 35. The cleaning process of the spindle motor 15b is allowed.

FIG. 12 schematically illustrates the configuration of a spindle motor 15c according to a fourth embodiment of the invention. In place of the fluid bearing, a pair of ball bearings 65 are incorporated into the spindle motor 15c. A support shaft 66 is fixed to the bracket 27. The ball bearing 65 relatively and rotatably couples the spindle hub 34 to the support shaft 66. The ball bearing 65 is arranged in a cylindrical space 67 formed in the spindle hub 34. The cylindrical space 67 has a center axis on a rotational axis X3. The clearance 58 is formed between the bracket 27 and the flange 37.

An annular body 68 is arranged in the cylindrical space 67 outside from the ball bearing 65. The outer circumferential surface of the annular body 68 is attached to the inner circumferential surface of the spindle hub 34. The annular body 68 partitions the cylindrical space 67 around the support shaft 66. The annular body 68 forms the clearance 69 that is gradually made becomes narrower or smaller toward the outer end of the clearance 69 between the annular body 68 and the support shaft 66 throughout the circumference of the support shaft 66. In the formation of the clearance 58, the inner circumferential surface of the annular body 68 may be formed by an inclined surface that is close to the outer circumferential surface of the shaft 32 as the inclined surface is toward the outer end of the clearance 69. The clearance 69 has the same configuration as that of the clearance 59. The same configurations and structures as those of the spindle motors 15 and 15a are indicated by similar reference numerals. The clearances 58 and 69 of the spindle motor 15c prevent the entering of the pure water into the cylindrical spaces 35 and 67. The cleaning process of the spindle motor 15c is allowed.

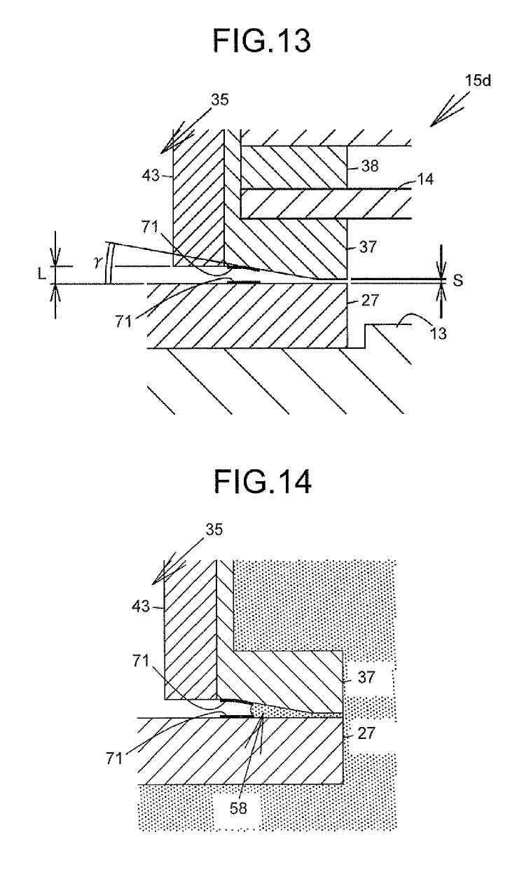

FIG. 13 schematically illustrates the configuration of a spindle motor 15d according to a fifth embodiment of the invention. A water repellent agent 71 is coated onto the upper surface of the bracket 27 and the lower surface of the flange 37 at the inner end of the clearance 58 of the spindle motor 15d. The water repellent agent 71 is coated throughout the circumference of the flange 37. The smallest space S is set to 0.15 mm or less. The largest space L is set to 0.30 mm or less. The smallest space S and the largest space L are set to be larger than 0 mm. A cross angle γ between the upper surface of the bracket 27 and the lower surface of the flange 37 is set to 10° or less. The cross angle γ is set to be larger than 0°. The same configurations and structures as those of the spindle motors 15 to 15c are indicated by similar reference numerals.

As illustrated in FIG. 14, in the cleaning process of the spindle motor 15d, the pure water entering into the clearance 58 generates a larger surface tension at the outer edge of the water repellent agent 71. The entering of the pure water into the cylindrical space 35 can be avoided by the action of the surface tension. The cleaning process of the spindle motor unit 61 is allowed. The water repellent agent 71 is also applicable to the spindle motors 15 to 15c. The water repellent agent 71 may be coated onto the inner circumferential surfaces of the annular bodies 49 and 68, the outer circumferential surface of the support shaft 18, and the outer circumferential surface of the support shaft 66. An oil repellent agent may be used in place of the water repellent agent 71.

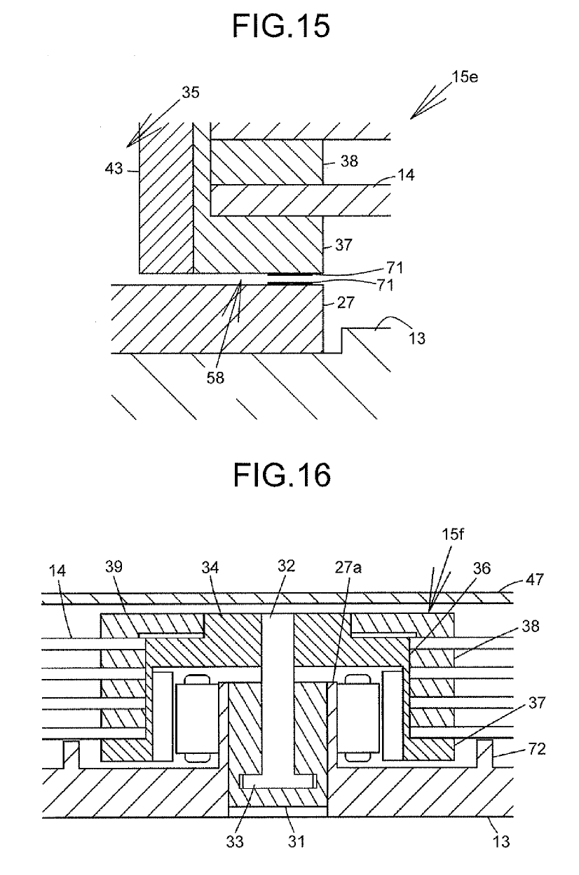

FIG. 15 schematically illustrates the configuration of a spindle motor 15e according to a sixth embodiment of the invention. The water repellent agent 71 is coated onto the upper surface of the bracket 27 and the lower surface of the flange 37 that extend in parallel with each other in the spindle motor 15e. The clearance between the bracket 27 and the flange 37 may be set to 0.2 mm or less. The clearance is set to 0 mm or more. The same configurations and structures as those of the spindle motors 15 to 15d are indicated by similar reference numerals. According to the spindle motor 15e, the pure water entering into the clearance generates a surface tension at the outer edge of the water repellent agent 71. The entering of the pure water into the cylindrical space 35 can be avoided. The cleaning process of the spindle motor 15e is allowed.

FIG. 16 schematically illustrates the configuration of a spindle motor 15f according to a seventh embodiment of the invention. The surface of the base 13 and the lower surface of the flange 37 of the spindle motor 15f extend in parallel with each other. The clearance may be formed of the related art size between the surface of the base 13 and the lower surface of the flange 37. A cylindrical portion 72 is erected from the bottom plate of the base 13 outside the spindle hub 34. The height of the cylindrical portion 72 from the bottom plate of the base 13 is set to be lower than the height of the upper end of the flange 37 from the bottom plate of the base 13. The same configurations and structures as those of the spindle motors 15 to 15e are indicated by similar reference numerals.

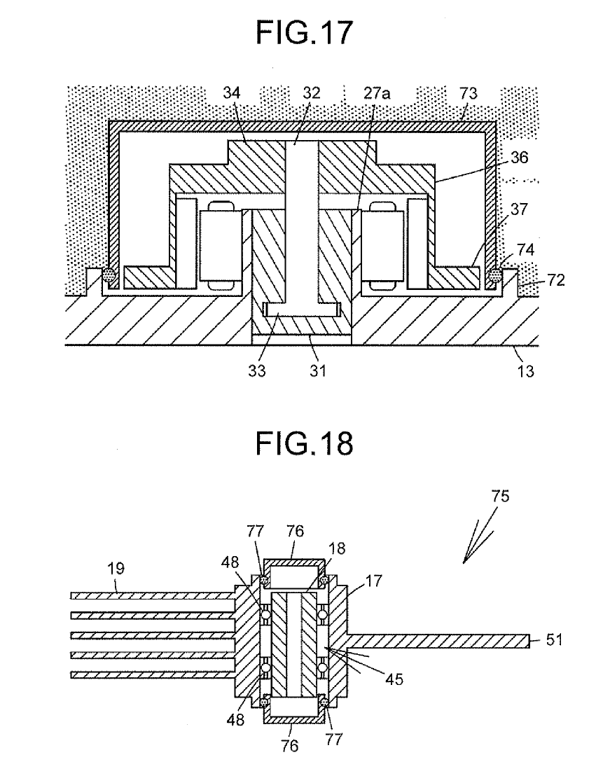

In the cleaning process, as illustrated in FIG. 17, a cylindrical cap 73 defining the cylindrical space is fitted into the cylindrical portion 72. The spindle motor 15f and the cap 73 configure a spindle motor unit. The spindle hub 34 is housed in the cylindrical space of the cap 73. An annular elastic body 74 is attached to the lower end of the cap 73 throughout the circumference of the outer edge of the cap 73. Rubber and plastic are used for the elastic body 74. When the cap 73 is fitted into the cylindrical portion 72, the elastic body 74 is interposed between the cap 73 and the cylindrical portion 72. The entering of the pure water into the cylindrical space of the cap 73 can be avoided in the cleaning process. Dust particles can be removed from the outer surface of the base 13.

FIG. 18 schematically illustrates a carriage assembly unit 75 according to an embodiment of the invention. The incorporation of the annular body 49 is omitted in the carriage assembly unit 75. A pair of caps 76 and 76 are fitted into the carriage block 17. An annular elastic body 77 is interposed between the lower end of each of the caps 76 and the inner circumferential surface of the carriage block 17. Rubber and plastic are used for the elastic body 77. The cap 76 seals the cylindrical space. The entering of the pure water into the cylindrical space 45 can be avoided for the cleaning process. Dust particles can be removed from the surface of the carriage block 17.

While certain embodiments of the inventions have been described, these embodiments have been presented byway of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A spindle motor comprising:
a cylindrical body configured to define a cylindrical space with a center axis on a rotational axis;
a rotor comprising an annular body configured to be connected to one end of the cylindrical body and define an opening of the cylindrical space; and
a stator configured to close the opening while rotatably supporting the rotor, wherein
a clearance is formed between the stator and the annular body throughout circumference of the annular body, and
the clearance becomes narrower in a direction away from the cylindrical space.

2. The spindle motor according to claim 1, wherein the stator is configured to face the rotor with a smallest space in between, the smallest space being defined by an outer end of the clearance.

3. The spindle motor according to claim 1, wherein the cylindrical space is opened only at the opening.

4. The spindle motor according to claim 1, wherein the rotor and the stator are configured to be coated with a water repellent agent at an inner end of the clearance.

5. A recording medium drive comprising:
a housing;
a cylindrical body in the housing, the cylindrical body configured to define a cylindrical space with a center axis on a rotational axis;
a rotor comprising an annular body configured to be connected to one end of the cylindrical body and define an opening of the cylindrical space; and
a stator configured to close the opening while rotatably supporting the rotor, wherein
a clearance is formed between the stator and the annular body throughout circumference of the annular body, and
the clearance becomes narrower in a direction away from the cylindrical space.

6. A spindle motor comprising:
a cylindrical support shaft with a center axis on a rotational axis;
a cylindrical body configured to define a cylindrical space with a center axis on a rotational axis and receive the support shaft in the cylindrical space;
a bearing in the cylindrical space, the bearing configured to couple the support shaft and the cylindrical body so that the support shaft and the cylindrical body are relatively movable; and
an annular body configured to partition the cylindrical space around the support shaft and define a clearance that becomes narrower toward an outer end of the clearance between the support shaft and the cylindrical body throughout circumference of the support shaft.

7. The spindle motor according to claim 6, wherein a smallest space is defined by the outer end of the clearance.

8. A recording medium drive comprising:
a housing;
a cylindrical support shaft in the housing with a center axis on a rotational axis;
a cylindrical body configured to define a cylindrical space with a center axis on a rotational axis and receive the support shaft in the cylindrical space;
a bearing in the cylindrical space, the bearing configured to couple the support shaft and the cylindrical body so that the support shaft and the cylindrical body are relatively movable; and
an annular body configured to partition the cylindrical space around the support shaft and define a clearance that becomes narrower toward an outer end of the clearance between the support shaft and the cylindrical body throughout circumference of the support shaft.

9. A spindle motor comprising:
a cylindrical body configured to define a cylindrical space with a center axis on a rotational axis;
a rotor comprising an annular body configured to be connected to one end of the cylindrical body and define an opening of the cylindrical space; and
a stator configured to close the opening while rotatably supporting the rotor, wherein
a clearance is formed between the stator and the annular body throughout circumference of the annular body, and
the rotor and the stator are configured to be coated with a water repellent agent at an inner end of the clearance.

10. The spindle motor according to claim 9, wherein the cylindrical space is opened only at the opening.

11. A recording medium drive comprising:
a housing;
a cylindrical body in the housing, the cylindrical body configured to define a cylindrical space with a center axis on a rotational axis;
a rotor comprising an annular body configured to be connected to one end of the cylindrical body and define an opening of the cylindrical space;
a stator configured to close the opening while rotatably supporting the rotor, a clearance being formed between the stator and the annular body throughout circumference of the annular body; and
a water repellent agent configured to be applied to the rotor and the stator at an inner end of the clearance.

12. A spindle motor unit comprising:
a cylindrical body configured to define a cylindrical space with a center axis on a rotational axis;
a rotor comprising an annular body configured to be connected to one end of the cylindrical body and define an opening of the cylindrical space;
a stator configured to close the opening while rotatably supporting the rotor, the stator comprising a base configured to form a clearance between the stator and the annular body throughout circumference of the annular body;
a cylindrical portion formed in the base around the rotor;
a cap configured to be fitted in the cylindrical portion, the rotor being housed between the cap and the base; and
an elastic body configured to be interposed between the cylindrical portion and the cap.

13. A carriage assembly comprising:
a cylindrical support shaft with a center axis on a rotational axis;
a carriage block body configured to define a cylindrical space with a center axis on a rotational axis and receive the support shaft in the cylindrical space;
a carriage arm extending from the carriage block body;
a bearing in the cylindrical space, the bearing configured to couple the support shaft and the carriage block body so that the support shaft and the carriage block body are relatively movable; and
an annular body configured to partition the cylindrical space around the support shaft and define a clearance that becomes narrower toward an outer end of the clearance between the support shaft and the carriage block body throughout circumference of the support shaft.

14. A recording medium drive comprising:
a housing;
a cylindrical support shaft in the housing with a center axis on a rotational axis;
a carriage block body configured to define a cylindrical space with a center axis on a rotational axis and receive the support shaft in the cylindrical space;
a carriage arm extending from the carriage block body;
a bearing in the cylindrical space, the bearing configured to couple the support shaft and the carriage block body so that the support shaft and the carriage block body are relatively movable; and
an annular body configured to partition the cylindrical space around the support shaft and define a clearance that becomes narrower toward an outer end of the clearance between the support shaft and the carriage block body throughout circumference of the support shaft.

15. A carriage assembly unit comprising:
a cylindrical support shaft with a center axis on a rotational axis;
a carriage block body configured to define a cylindrical space with a center axis on a rotational axis and receive the support shaft in the cylindrical space;
a carriage arm extending from the carriage block body;
a bearing in the cylindrical space, the bearing configured to couple the support shaft and the carriage block body so that the support shaft and the carriage block body are relatively movable;
a cap configured to be fitted in the carriage block body and seal the cylindrical space; and
an elastic body configured to be interposed between the carriage block body and the cap.
